(19) United States
(12) Patent Application Publication
(10) Pub. No.: US 2020/0008369 A1
(43) Pub. Date: Jan. 9, 2020

(54) TRANSLUCENT HORTICULTURAL APPARATUS FOR MANAGING SOIL CONDITIONS

(71) Applicant: Lacebark, Inc., Stillwater, OK (US)

(72) Inventor: Carl E. Whitcomb, Stillwater, OK (US)

(21) Appl. No.: 16/026,177

(22) Filed: Jul. 3, 2018

(51) Int. Cl. A01G 13/02

(52) U.S. Cl. CPC A01G 13/0275

(57) ABSTRACT

A horticultural apparatus is provided for managing soil conditions. The horticultural apparatus includes a nonporous and translucent polymeric sheet forming a two-dimensional array of basins defining an upper plane and a lower plane. Each basin has a rim in the upper plane, a base in the lower plane, sidewalls that slope inwardly from the rim to the base, and a hole in the base. The polymeric sheet connects the rim of each basin to the rims of each adjacent basin to form a continuous canopy between the basins. The continuous canopy preferably prevents air convection through the polymeric sheet when the hole in each basin is pressed against the soil. Embodiments of the horticultural apparatus may be used to warm the soil, control weed growth, control water run-off and extend the life of an organic mulch.

### BACKGROUND

The present disclosure relates to a horticultural apparatus for managing soil conditions and a method of using the horticultural apparatus to improve conditions for growing the plant.

### BACKGROUND OF THE RELATED ART

Horticulture is the science and practice of growing plants, such as vegetables, fruit, ornamental plants, flowers, and other cultivated plants. One common horticultural practice is the application of a mulch material over the soil surface around a plant. The mulch may serve to conserve moisture and reduce weed growth in the soil beneath the mulch. Many organic materials function well as a mulch, such as tree bark and hay. However, these organic materials break down rapidly and must be periodically reapplied.

### BRIEF SUMMARY

One embodiment provides a horticultural apparatus for managing soil conditions. The horticultural apparatus comprises a nonporous and translucent polymeric sheet forming a two-dimensional array of basins defining an upper plane and a lower plane. Each basin has a rim in the upper plane, a base in the lower plane, sidewalls that slope inwardly from the rim to the base, and a hole in the base. The polymeric sheet connects the rim of each basin to the rims of each adjacent basin to form a continuous canopy between the basins.

### BRIEF DESCRIPTION OF THE SEVERAL VIEWS OF THE DRAWINGS

FIG. 1A is a perspective view of the top surface of a horticultural apparatus according to one embodiment.

FIG. 1B is a perspective view of the bottom surface of the horticultural apparatus of FIG. 1A.

FIG. 2A is a schematic side view of the horticultural apparatus of FIGS. 1A-B.

FIG. 2B is a schematic side view of the horticultural apparatus of FIG. 2A that has been positioned over an area of soil.

FIGS. 3A-B are plan views of a portion of a horticultural apparatus illustrating circular basins in two different configurations.

FIGS. 4A-B are plan views of a portion of a horticultural apparatus illustrating hexagonal basins in two different configurations.

FIGS. 5A-B are plan views of a portion of a horticultural apparatus illustrating square basins in two different configurations.

FIGS. 6A-D are cross-sectional side views of a single basin illustrating four different slopes for the sidewalls.

FIG. 7A is a diagram a roll of the horticultural apparatus.

FIG. 7B is a partial expanded view of the roll in FIG. 7A illustrating how the material may be bent.

FIG. 8 is a side view of two units of the horticultural apparatus that have been overlapped so that a row of basins along the edge of one unit are nested into a row of basins along the edge of another unit.

FIG. 9 is a graph of the results from a soil warming test which compared the soil temperature at a four-inch depth for the translucent horticultural apparatus, bare soil, opaque black polymer sheet, and hay mulch.

FIG. 10A is a plan view of the horticultural apparatus and an illustration of how the apparatus may be cut to facilitate installing a plant in the soil beneath the apparatus.

FIG. 10B is a schematic side view of the horticultural apparatus positioned on the soil, where the horticultural apparatus has been cut and folded as illustrated in FIG. 10A to facilitate the installed plant.

### DETAILED DESCRIPTION

One embodiment provides a horticultural apparatus for managing soil conditions. The horticultural apparatus comprises a nonporous and translucent polymeric sheet forming a two-dimensional array of basins defining an upper plane and a lower plane. Each basin has a rim in the upper plane, a base in the lower plane, sidewalls that slope inwardly from the rim to the base, and a hole in the base. The polymeric sheet connects the rim of each basin to the rims of each adjacent basin to form a continuous canopy between the basins. The continuous canopy preferably prevents air convection through the polymeric sheet when the hole in each basin is pressed against the soil.

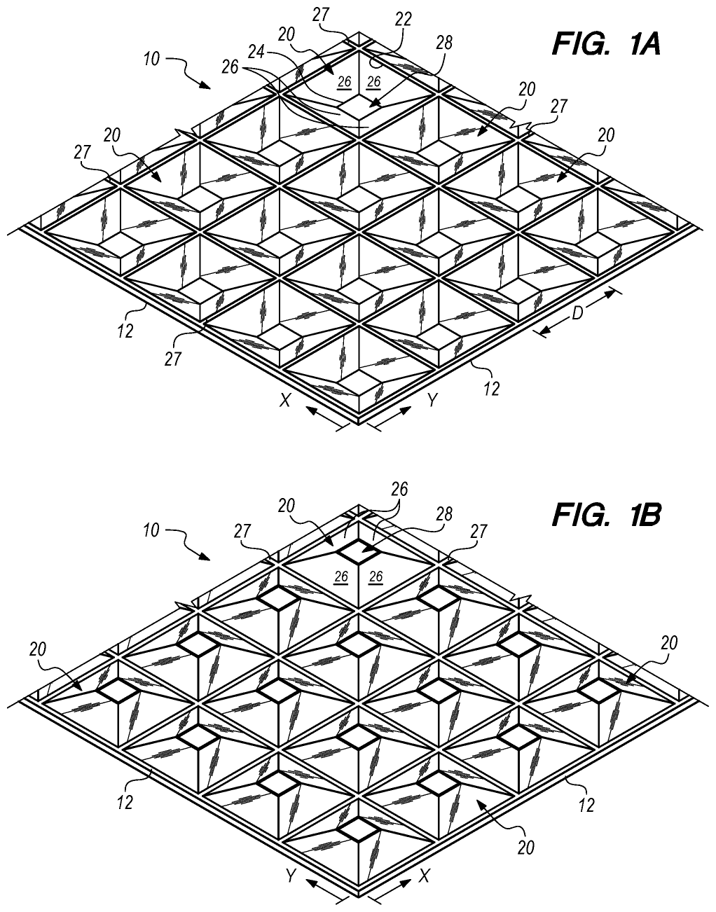

FIG. 1A is a perspective view of the top surface of a horticultural apparatus 10 according to one embodiment. The horticultural apparatus 10 includes a nonporous and translucent polymeric sheet 12 forming a two-dimensional array of basins 20. The two-dimensional array shown includes a total of 16 basins 20 in a 4×4 array, which may be considered to be arranged in rows and columns. Each basin 20 has a rim 22 in an upper plane, a base 24 in a lower plane, sidewalls 26 that slope inwardly from the rim 22 to the base 24, and a hole 28 in the base 24. A portion 27 of the polymeric sheet 12 connects the rim of each basin to the rims of each adjacent basin to form a continuous canopy between the basins. In a preferred option, each of the basins 20 is the same size and shape.

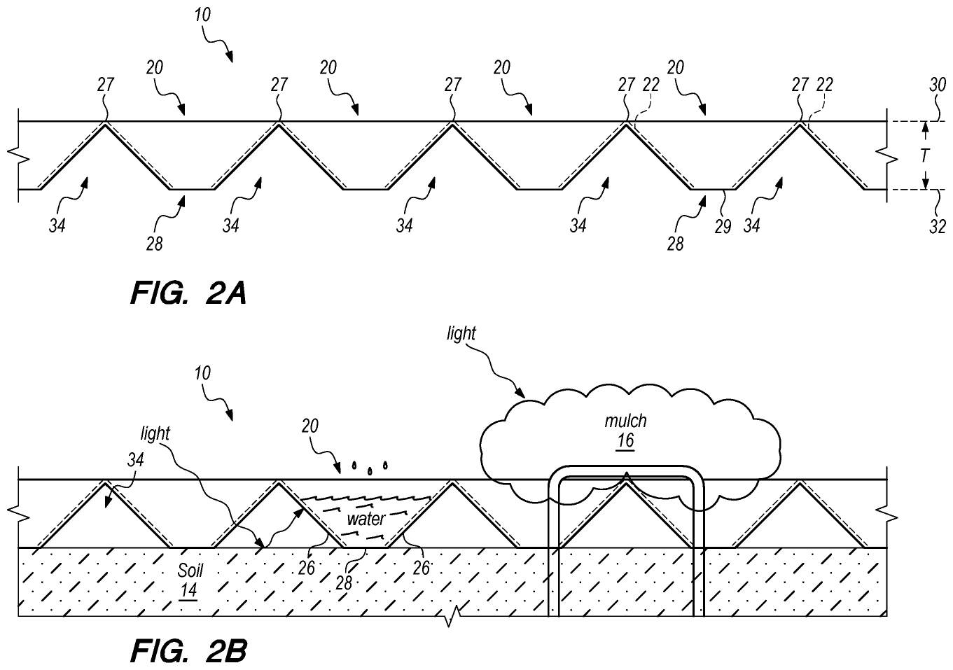

In one embodiment, the rim 22 of each basin 20 has a diameter D of between 0.5 and 3 inches and a vertical relief or depth (see dimension T in FIG. 2A) of between 0.5 and 2 inches. In one preferred embodiment, the rim of the basin has a diameter D of about one inch and a vertical relief (depth) T of about one inch. It should be recognized that the dimensions of the basins 20 are relevant to the shape and size of air spaces formed under the horticultural apparatus 10 and around the basins 20. The dimensions of the basins 20 also have an effect on the strength of the horticultural apparatus 10 and, more specifically, have an effect on the strength and resilience of the horticultural apparatus when the weight of a person is applied over the top. It is important that the weight of a person walking on the horticultural apparatus 10 does not eliminate the air spaces, either by permanently collapsing the structure of the horticultural apparatus 10 or by driving the basins 20 deep into the soil. Furthermore, the strength and resilience allows the horticultural apparatus 10 to be taken up in the Fall for use during the next Spring growing season.

In the embodiment shown, the sidewalls 26 of each basin 20 define a frustum having a major base in the upper plane and a minor base in the lower plane. In other words, the frustum has a major base and a minor base with a smaller diameter than the major base, where the major base of the frustum is defined by the rim 22 of the basin 20 and the minor base of the frustum is defined by the base or hole 28 of the basin 20. The basin 20 shown defines a right frustum having square bases. However, the horticultural apparatus may have many other shapes of basins as disclosed below.

FIG. 1B is a perspective view of the bottom surface of the horticultural apparatus 10 of FIG. 1A. When the horticultural apparatus if made from a polymeric sheet having a uniform thickness, the bottom surface is the exact opposite of the top surface. In other words, the bottom surface may be considered to be a three-dimensional negative image of the top surface. According to preferred embodiments, a description of the shape and dimensions of the top surface (FIG. 1A) may fully dictate the shape and dimensions of the bottom surface (FIG. 1B). However, the sidewalls 26 of the basins 20 and the portions 27 that connect the rims 22 of the basins 20 may be referred to collectively as a canopy since these element of the translucent polymeric sheet 12 for a roof-like structure that functions as a miniature greenhouse. The canopy is total portion of the polymeric sheet that is supported above the soil to leave an air space between the polymeric sheet and the soil.

Various embodiments of the horticultural apparatus may be made by thermoforming a plastic sheet or film. The plastic film may be pulled through a process in which the film is warmed and then is immediately engaged by one or more formers that have a complementary shape to the top or bottom surface of the horticultural apparatus. A vacuum may be applied to the former in order to pull the warmed polymeric sheet down firmly against each surface of the former. Then the vacuum is released, and the shaped polymeric sheet is moved to a cooling area to allow the newly formed shape of the sheet to stabilize. In one option, the shaped polymeric sheet is passed over a hot wire that removes the tips of the formed cones (i.e., forms the hole in the basin). It is not necessary for the holes to be any particular shape and may even be irregular holes due to artifacts of the process forming the holes. Alternatively, the lower end of each basin may have a hole shaped to optimize contact with the soil and support of the horticultural apparatus over the soil.

In one embodiment, the polymeric sheet is made with polystyrene. However, it is believed that the horticultural apparatus may be made using many other polymers. For example, the polymeric sheet may be made from a sheet of any polymer that can be thermoformed. A non-limiting list of other polymers includes polyolefins, co- or terpolymers, and vinylester copolymers, such as polyethylene (i.e., LDPE), polyethylene/ethylene vinyl acetate, polypropylene or fluoropolymers, co- or terpolymers such as polytetrafluoro-ethylene (PTFE) and polyvinylidene chloride (PVDC), polyvinylchloride (PVC), polycarbonate (PC), polymethylmethacrylate (PMMA) or mixtures of the above. Still other polymers may include ethylene homopolymers or copolymers such as low-density polyethylene, high-density polyethylene, ethylene butene-1 copolymers, ethylene-4-methylpentene-1 copolymers, ethylene-vinyl acetate copolymers, ethylene-acrylic acid copolymers, ethylene methyl methacrylate copolymers, ethylene-vinyl acetate-methyl methacrylate copolymers, ethylene-ethyl acrylate copolymers, polypropylene, and vinyl chloride resins. These foregoing polymers may be used alone or in a combination of two or more of those described. The thickness of the polymeric sheet may be any suitable thickness without limitation. However, various embodiments may having a thickness of between 8 and 40 mils (i.e., a mil is one thousandth of an inch).

As used herein, a “sheet” is a material that is thin in comparison to its length and breadth, and has a surface or part of a surface in which it is possible to pass from any one point of it to any other without leaving the surface. Therefore, a sheet may have three-dimensional features, such as the basins described herein. A “diameter” is, for any convex shape in a plane, the largest distance that can be formed between two opposite parallel lines tangent to its boundary. Accordingly, the diameter of a square is the length of one side, while the diameter of a rectangle is the length of the longest side. Of course, other polygons, circles and ellipses will also have a diameter. It should be understood that a reference to the “diameter” of a shape does not limited the shape to a circle. A “translucent” material allows the passage of light. A “transparent” material is a subset of translucent materials where the transparent material not only allows the transport of light but also allows for image formation.

FIG. 2A is a schematic side view of the horticultural apparatus 10 of FIG. 1A. In the side view, a single row or column of the basins 20 are shown. The polymeric sheet includes portions 27 that connect each basin 20 to adjacent basins 20. Consistent with FIGS. 1A-B, the horticultural apparatus 10 includes a two-dimensional array of basins defining an upper plane 30 and a lower plane 32. For example, the upper plane 30 may be defined by the rims 22 of each basin 20 and the portions 27 that connect the basins 20. Furthermore, the lower plane 32 may be defined by a base 29 of each basin 20, where the base 29 includes the hole 28. In one option, the upper plane 30 and the lower plane 32 are separated by a distance between 0.5 and 2 inches. In other words, preferred embodiments of the horticultural apparatus 10 may have a thickness of between 0.5 and 2 inches.

In the embodiments of FIGS. 1A-B and 2A, the only holes through the polymeric sheet are the holes 28 that are formed in bottom of each basin 20. Therefore, the horticultural apparatus 10 forms a continuous canopy 34 between and around the basins 20. The continuous canopy 34 is elevated by the basins 20 to form one or more air spaces beneath the canopy, and the continuous canopy preferably prevents air convection through the polymeric sheet when the hole 28 in each basin is pressed against the soil.

The translucent canopy 34 and the air spaces beneath the canopy 34 function as one or more miniature greenhouses. For the purpose of soil warming and weed control under the canopy, the size of the miniature greenhouses will preferably optimize heating. Having a canopy that is held up off the soil to form an air space between the canopy and soil is important. Areas of the translucent polymer that are in direct physical contact with the soil do not make a significant contribution to heating. However, the canopy should also remain a close distance above the soil, since an elevated canopy will be exposed to the same amount of radiant energy yet have a greater amount of air to heat. The horticultural apparatus is preferably able to achieve sufficiently high temperatures to kill or stunt weeds that have begun to grow in the soil beneath the canopy.

FIG. 2B is a schematic side view of the horticultural apparatus 10 of FIG. 2A that has been positioned over an area of soil 14. With the horticultural apparatus in this position, the hole 28 in the base of each basin 20 exposes a downwardly directed edge of the sidewalls 26 to engage the soil 14 and perhaps penetrate a short distance into the soil. The soil 14 blocks the hole 28 such that water from rain or irrigation will tend to collect and accumulate in the basin 20. As the soil is able to absorb more moisture, the water can slowly enter the soil. However, the water is prevented from simply running off the soil and eroding the soil even if the rain or irrigation occurs suddenly. If the soil is uneven or includes lumps when the horticultural apparatus is initially applied to the soil, water passing through the holes 28 will tend to soften and break up the lumps and cause the soil to settle and smooth out. In a short period of time, the holes should engage the soil and prevent air from passing through the holes.

Because the horticultural apparatus is made with a translucent polymer, radiant energy from sunlight penetrates the translucent polymer sheet and causes heat to become trapped in the air space between the polymer sheet and the soil surface. Specifically, the horticultural apparatus takes advantage of the “greenhouse effect” to capture and retain heat under the canopies 34. Any area of the canopies 34 that is supported above the surface of the soil 14 (i.e., any area of the apparatus that is not in direct contact with the soil) should allow radiant energy to penetrate the translucent polymer and heat the soil and air under the canopies 34. Specifically, the air space above the soil and below the sheet extends between and around each of the basins. This air space is also believed to moderate the temperature of the soil, since at a certain air temperature the radiation losses from the air space reach an equilibrium with the heat being trapped by the air space. Accordingly, the air space temperature does not simply continue to escalate without limitation.

Heating in this manner will cause rapid warming of the soil such that vegetable crops and other plants may be planted earlier than in the absence of the horticultural apparatus. The heat generated using the horticultural apparatus may also kill pathogens and weeds through a process called solar sterilization. Although weed seed beneath the canopy may germinate due to light exposure, the weeds are soon killed or stunted by excess heat.

Mulch 16 may be applied over the top of the horticultural apparatus after the desired root zone of the soil has warmed to a desired temperature range, such as approximately 70 to 80 degrees F. mulch at a depth of four inches. The mulch is preferably spread over the entire top surface of the horticultural apparatus. The mulch shades the surface of the translucent polymeric sheet such that further heating from radiant energy is reduced or blocked entirely and such that weed growth is prevented or limited. However, water will pass through the mulch and will still collect in the basins for slow entrance into the soil. The horticultural apparatus works in conjunction with the mulch to minimize loss of heat and moisture from the soil during cool periods and to stabilize soil temperature.

The horticultural apparatus also provides physical support to the organic mulch and prevents contact between the mulch and the soil surface such that the mulch lasts much longer. Organic materials applied directly to soil as mulch are relatively short lived. Soils support vast microbial populations such that organic material in direct contact with the moist interface of soil, decomposition of the organic material is typically quite rapid. However, when mulch is applied over the horticultural apparatus described herein, the mulch is separated from the soil and water is allowed to drain from the mulch layer into the soil. As a result, the horticultural apparatus greatly reduces the mulch decomposition. In one option, mulch that has been applied over the horticultural apparatus may be collected at the end of a growing season and then later reused in the same manner in a subsequent growing season.

Embodiments of the horticultural apparatus 10 may cover, for example, about 95% or more of the soil surface, leaving only about 5% of the soil surface exposed through the holes 28 at the base of each basin 20. However, the coverage of the soil may vary, perhaps from 75% to 98% soil coverage (25% to 2% soil exposure), based on the size and spacing of the holes. When an effective preemergent herbicide, such as trifluralin or prodiamine granules, is applied over the surface of one or more units of the horticultural apparatus, the herbicide settles or washes into the basins and is directed into the soil that is exposed through the hole in the bottom of the basin to prevent weed seed germination in the exposed soil. Since the herbicide only contacts a small percentage of the soil surface area covered by the horticultural apparatus, the roots of desirable plants growing in the soil are less likely to experience adverse effects of the herbicides. Still, the total amount of herbicide is preferably sufficient to control weeds in the small percentage of the soil surface that is exposed (i.e., about 5% of the soil surface area) and receives the herbicide. Any weeds that begin to grow in the soil beneath the translucent canopy (i.e., the 95% of the soil area covered by the horticultural apparatus) before the mulch is applied are killed or stunted by heat. Once mulch has been applied over the top of the horticultural apparatus, the lack of light reaching the soil will prevent or limit the extent of weed growth across the entire area of soil covered by the mulch. The preemergent herbicide previous applied over the horticultural apparatus is preferably a “soft herbicide” that is broken down by microorganisms in the soil at a rate that leaves no residue from one season to the next.

In one method, the translucent horticultural apparatus is positioned over the soil for a few days to let the root zone of the soil warm up to the optimum range for root growth. Then, a slit or hole is cut through the apparatus so that a young plant, which was started in a nursery, can be planted in the soil through the cut hole. The apparatus may be cut in any manner, such as to remove an area of the polymeric sheet or to form a flap that is folded over or under the apparatus.

At about the same time as planting, the translucent horticultural apparatus may be covered with a mulch material of any kind. The mulch blocks light from reaching the translucent horticultural apparatus, such that heating of the soil does not become excessive. However, applying mulch over the top of the horticultural apparatus allows the horticultural apparatus to be left in place over the soil for the entire growing season. The horticultural apparatus will preferably serve to: (A) aid in retaining heat in the optimal range for the root zone; (B) aid in water collection and controlled water entrance into the soil; (C) aid in controlling weeds both in the soil areas covered by the apparatus and in the exposed soil areas at the holes in the lower end of each basin that receive a preemergent herbicide; and (D) extend the life of an organic mulch. In a non-limiting application, the horticultural apparatus may be used to support the growth of vegetables, landscape plants, and flowers.

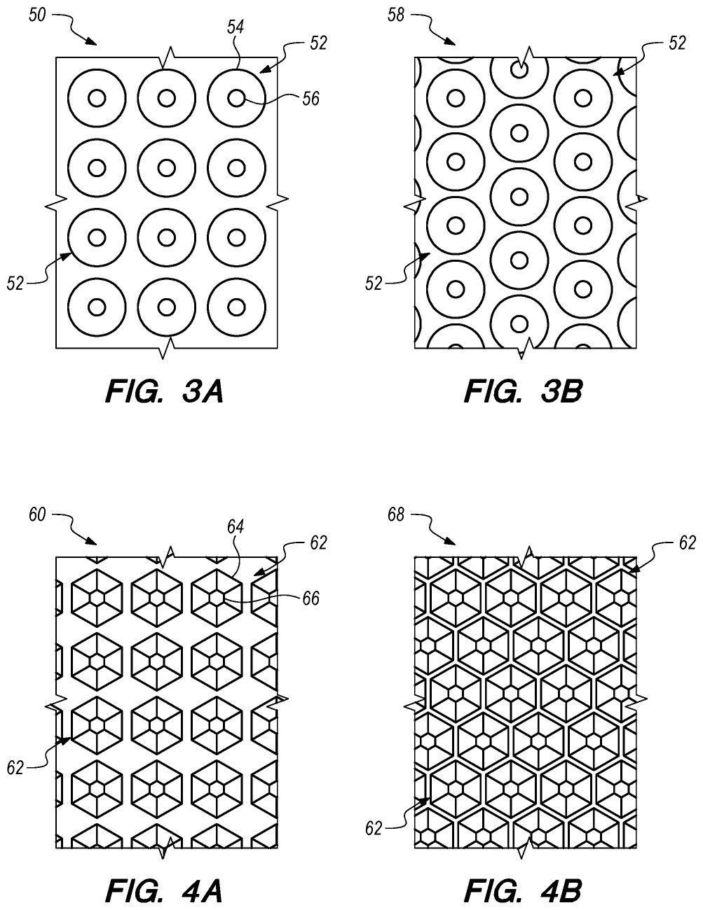

FIGS. 3A-B are plan views of a portion of a horticultural apparatus 50 illustrating circular basins in two different configurations. In FIG. 3A, the horticultural apparatus 50 has a structure similar to the horticultural apparatus 10 shown in FIGS. 1A-B and FIGS. 2A-B except that the basins 52 are circular. Accordingly, each basin 52 has a circular rim 54 and a circular base 56 with a hole in the base. The horticultural apparatus 58 shown in FIG. 3B has a structure similar to the horticultural apparatus 50, except that the rims of the circular basins 52 in the two-dimensional array are disposed in a close-packed arrangement.

FIGS. 4A-B are plan views of a portion of a horticultural apparatus illustrating hexagonal basins in two different configurations. In FIG. 4A, the horticultural apparatus 60 has a structure similar to the horticultural apparatus 10 shown in FIGS. 1A-B and FIGS. 2A-B except that the basins 62 are hexagonal. Accordingly, each basin 62 has a hexagonal rim 64 and a hexagonal base 56 with a hole in the base. The horticultural apparatus 68 shown in FIG. 4B has a structure similar to the horticultural apparatus 60, except that the rims of the hexagonal basins 52 in the two-dimensional array are disposed in a close-packed arrangement. As shown, the hexagonal basins 62 may be defined by a right frustum having a major base in the upper plane of the apparatus and a minor base in the lower plane of the apparatus. Although the horticultural apparatus 60, 68 are show with hexagonal basins 62, the basins may be defined by any right frustum having major and minor bases that are a regular convex polygon.

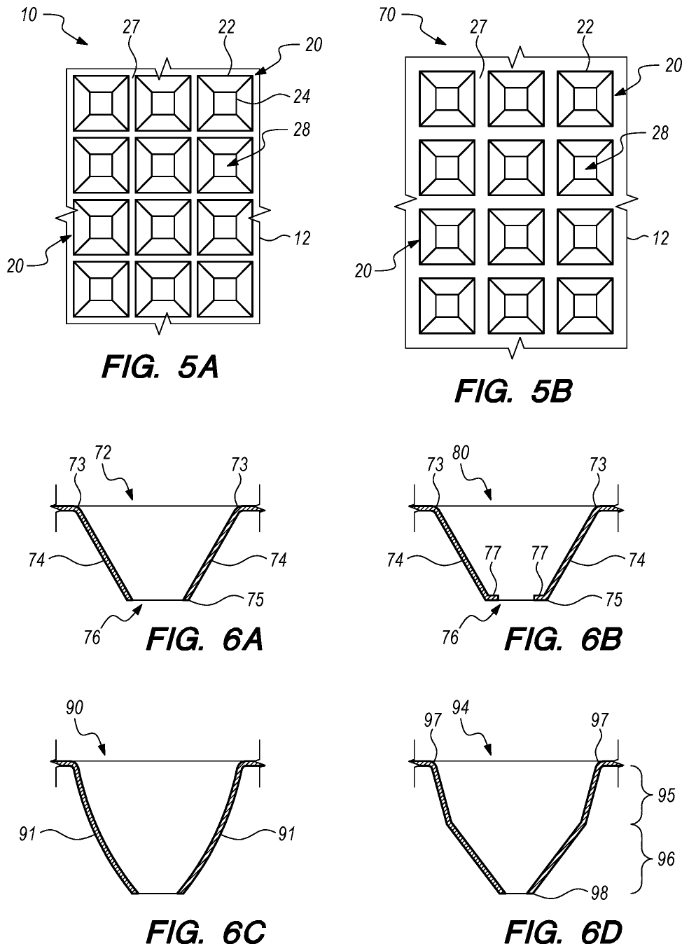

FIGS. 5A-B are plan views of a portion of a horticultural apparatus illustrating square basins in two different configurations. FIG. 5A is a portion of the horticultural apparatus 10 of FIGS. 1A-B and FIGS. 2A-B, which has a plurality of basins 20 each having a rim 22 and a square base 24 with a hole 28 formed in the base. FIG. 5B shows a horticultural apparatus 70 that is similar to the horticultural apparatus 10 of FIGS. 1A-B, FIGS. 2A-B and FIG. 5A, except that the basins 20 are separate by a distance. Accordingly, the portion 27 of the polymeric sheet 12 that connects the rim 24 of each basin 20 to the rims of each adjacent basin is larger for the horticultural apparatus 70 than for the horticultural apparatus 10. Both apparatus 10 and apparatus 70 form a continuous canopy between the basins, but apparatus 70 has a canopy that is expected to cover a higher percentage of the soil surface (i.e., a lesser percentage of soil surface exposed by the holes 28). However, in order for the horticultural apparatus to provide sufficient strength and adequate water collection, any distance separating the rims 24 of the basins in the two-dimensional array is preferably less than a diameter of the rims.

FIGS. 6A-D are cross-sectional side views of a single basin illustrating four different slopes for the sidewalls. The structures and features of each basin are intended to illustrate features that may be implement alone or in various combinations. The basins may include even further sidewall and base configurations consistent with the purposes described herein. However, each basin preferably has a continuously downward slope that will not pool water.

FIG. 6A illustrates a basin 72 including straight sidewalls 74 that have a constant slope from the rim 73 to the base 75 wherein a hole 76 is the entire width of the base. FIG. 6B illustrates a basin 72 including straight sidewalls 74 that have a constant slope from the rim 73 to the base 75. However, the hole 78 formed in the base 75 is smaller than the base 75 such that a lip 77 remains in the base 75 between the sidewalls 74 and the hole 78. The lip 77 preferably does not prevent water from exiting downwardly through the hole to enter the soil.

FIG. 6C illustrates a basin 90 including concave sidewalls 91. FIG. 6D illustrates a basin 94 that has a first profile in an upper portion 95 that extends downward from the rim 97 and a second profile in a lower portion 96 that extends downward from the upper portion 95 to the base 98. In this non-limiting example, the sidewalls in both the upper and lower portions 95, 96 may be frustums with different diameters and lengths. For example, the upper portion 95 may include a first frustoconical sidewall having a first slope and the lower portion may include a second frustoconical sidewall having a second slope. In further examples, the sidewalls in the upper and lower portions 95, 96 may be defined by right frustums having a convex regular polygon for each base.

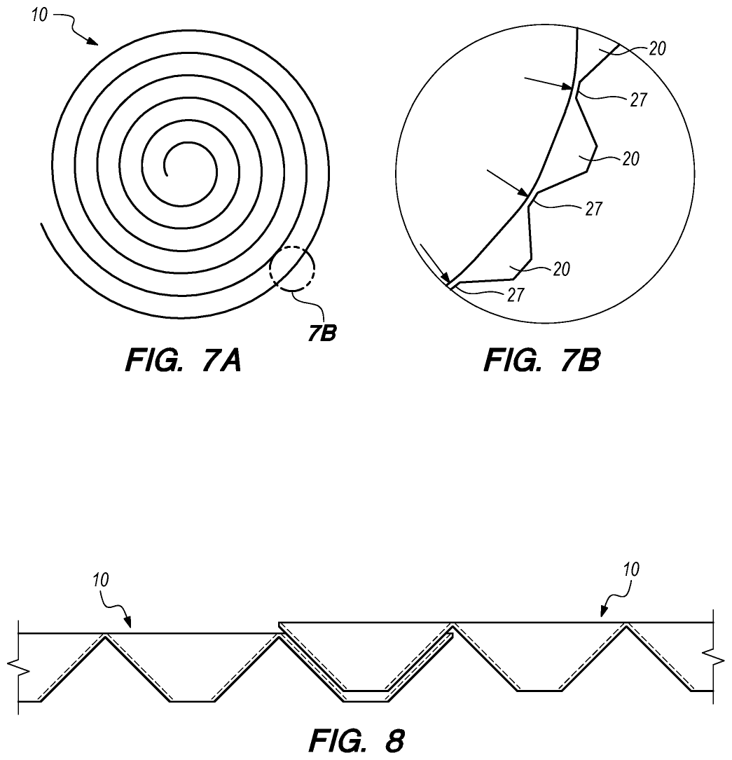

FIG. 7A is a diagram a roll of the horticultural apparatus 10, including an expanded view illustrating how the polymeric sheet may be bent. The horticultural apparatus 10 may be configured to be bendable so that a length of the apparatus may be rolled up for storage or shipment. When being positioned over an area of soil, the horticultural apparatus 10 may be unrolled across the soil with the base of the basins 20 directed for contact with the soil surface (see FIG. 2B). As shown in FIG. 7B, horticultural apparatus 10 may be most easily bent at the connecting portions 27 between the basins 20. The three-dimensional structure of the basins tends to resist bending, but the connecting portions 27 may be easily bent. In the example of FIG. 1A, the horticultural apparatus 10 has a two-dimensional array of basins 20 arranged in parallel rows, such that the polymeric sheet is bendable along the connecting portions 27 between the rows.

FIG. 8 is a side view of two units of the horticultural apparatus 10 that have been overlapped so that a row of basins 20 along the left-side edge of one unit (on the right) are nested into a row of basins along the right-side edge of another unit (on the left). In this manner, multiple units of the horticultural apparatus may be interlocked to continuously cover an area of soil that is greater than the width or length of a single unit of the horticultural apparatus. The ability to interlock units makes the individual units easier to handle, yet does not leave gaps between the units where week growth may occur. Optionally, landscaping staples or spikes may be driven into the soil through the holes in basins spaced apart across the units to hold the units of the horticultural apparatus in place. A staple or spike may be conveniently driven through over overlapped basins in order to secure the edges of both units with a single staple or spike.

### Example 1—Using the Horticultural Apparatus to Warm Soil

A four-day test was performed to measure the soiling warming characteristics of four different soil treatments. On Day 1 at 7:00 am, the air temperature was 28 F and the soil temperature was measured at a depth of 4 inches below the soil surface since the temperature at that depth is the most important in stimulating roots to grow and establish new plants. After measuring the soil temperature at a depth of 4 inches below the soil in four locations of a tilled garden area in full sun, three different soil coverings were placed over three of the locations for comparison with a fourth location that remained as bare soil. The three soil coverings included: (A) hay mulch as is commonly used, (B) an opaque black polymer sheet, and (C) a sheet of translucent bubble wrap.

The bubble wrap formed a two-dimensional array of air-filled plastic bubbles, where each bubble was roughly one inch in diameter and extended about ¾ inch from generally flat side surface. The bubble wrap was placed over the soil with the bubble side down and the generally flat side surface facing upward toward the sun. In this position, the air spaces between the bubbles and the soil acted as a complex of miniature greenhouses. Accordingly, the bubble wrap was the believed to replicate the soil warming characteristics of a horticultural apparatus as disclosed herein. However, the bubble wrap was not configured with basins that would collect water and would not withstand an individual walking on top of the bubble wrap.

The soil temperature at a depth of 4 inches was measured beneath each soil covering treatment and beneath the bare soil (control) at the following times: (1) Day 1 at 7:00 am (initial temperature), (2) Day 1 at 5:00 pm (after a daytime maximum air temperature of 74 F), (3) Day 2 at 7:00 am (air temperature of 56 F), (4) Day 2 at 5:00 pm (after a daytime high air temperature of 78 F), (5) Day 3 at 7:00 am (air temperature of 46 F), (6) Day 3 at 5:00 pm (after daytime high air temperature of 81 F), and (7) Day 4 at 7:00 am (air temperature of 34 F).

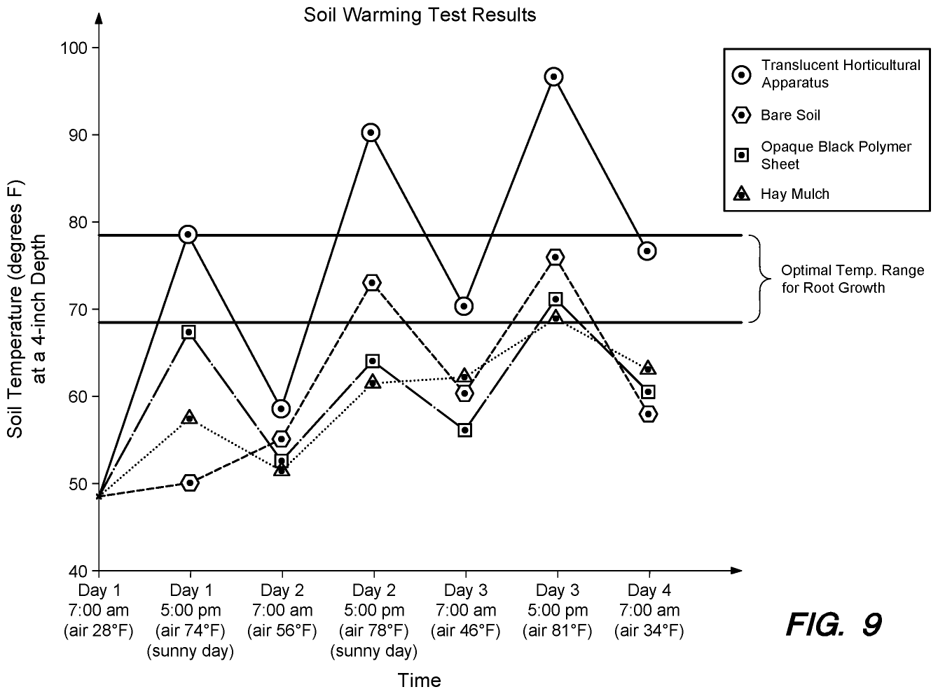

FIG. 9 is a graph of the results from the soil warming test which compared the soil temperature at a four-inch depth for the translucent horticultural apparatus, bare soil, opaque black polymer sheet, and hay mulch. For each of the soil covering treatments and the bare soil (control), the initial (Day 1 at 7:00 am) soil temperature of 48 F was slow to warm.

By the end of the second warm day (Day 2 at 5:00 pm) following a warm night of 56 degrees (Day 2 at 7:00 am), the soil temperature at a depth of 4 inches below the bare soil briefly increased into the desirable root growth temperature range of about 68-78 F before dropping back below that range. After the next day brought an afternoon temperature of 81 F (Day 3 at 5:00 pm), the soil temperature beneath the bare soil again increased into the desirable temperature range, but then again lost heat to the atmosphere and to the cool soil below 4 inches after a cold night of 34 degrees (Day 4 at 7:00 am). The opaque black polymer sheet and the hay mulch behaved somewhat similarly to the bare soil but showed some moderating of heat loss due to a small insulating effect.

The translucent horticultural apparatus did far better than the other soil covering treatments at heating the soil and retaining heat within the soil. The translucent horticultural apparatus caused the soil at a 4-inch depth to reach a much higher temperature (78 F) on the first day (Day 1 at 5:00 pm) than did any of the other treatments, then retained a higher temperature (58 F) through the first night (Day 2 at 7:00 am) while heat was being lost to the atmosphere and to the cooler laterally and downwardly surrounding soil. By Day 3, the translucent horticultural apparatus was able to maintain the soil temperature at a 4-inch depth in the middle of the optimum temperature range for root growth (Day 3 at 7:00 am). In fact, after three days, the temperature at a 4-inch depth beneath the translucent horticultural apparatus was about 17 degrees warmer than at a 4-inch depth beneath the bare soil. After three days, the horticultural apparatus was able to heat the soil at a 4-inch depth into the optimal temperature range for root growth and reduce the day/night soil temperature fluctuations.

In practical use, the horticultural apparatus may continue in use un-shaded (i.e., without a mulch layer over the top) for several days until the soil temp at a 4-inch depth is at the top of the desirable root zone temperature range. Then, the horticultural apparatus may be covered with mulch of any kind, such that further heating may be slowed or stopped, while maintaining the root zone within the desired temperature range to continue stimulating plant growth. Any weed seeds that may have germinated as the soil warmed will be stunted or killed by the increasing temperature under the canopy of the horticultural apparatus. Later, the addition of mulch over the horticultural apparatus will block light from reaching the soil, such that further weed growth is prevented. All the while, the array of basins will continue to minimize runoff and allow any water from rainfall or irrigation to enter the soil slowly.

### Example 2—Surface Temperature of the Horticultural Apparatus

After several days with daytime high air temperatures above 90 F, the soil temperature 4 inches below the surface was measured under each treatment from Example 1. The soil temperature at the 4-inch depth was 94 F below the translucent sheet, 81 F below the straw mulch, and 92 F below the bare soil surface. The soil temperature measurements were the same the next day, showing that the translucent sheet heats the soil to only modestly higher maximum temperatures than the temperature of bare soil.

The next morning, the air temperature at 7:00 am was 63 F, but the soil temperature at a 4 inch depth was 79 F below the bare soil (the bare soil heats up more, but loses heat faster), 74 F under the hay mulch, and was 86 F under the translucent sheet. These measurements show that the translucent sheet desirably reduced the fluctuation of soil temperatures in the primary root zone versus the hay mulch or bare soil.

A thermometer was also used to measure the top surface temperature of each treatment to determine which of the treatments would be the most likely to cause heat damage to plant leaves as they grow out and bend down to touch the surface of the treatments. With an air temperature of 92 F, the upper surface of the translucent sheet was 92 F, the upper surface of the hay mulch was 96 F, and the upper surface of the bare soil was 99 F. So, the surface temperature of the translucent sheet was actually cooler than bare soil and hay mulch, and would then be less likely to cause damage to plant leaves than would either the hay mulch or the bare soil.

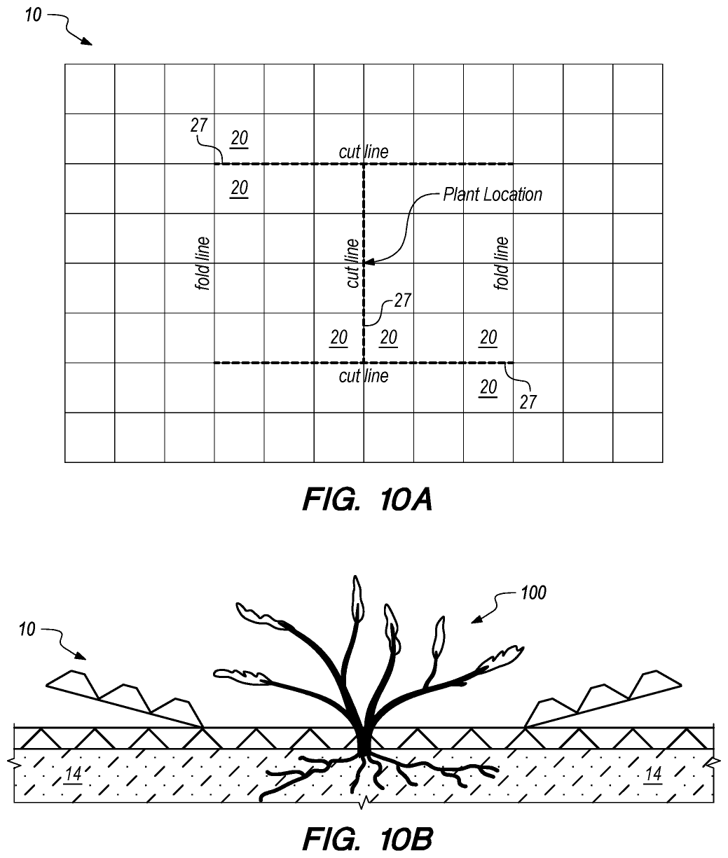

FIG. 10A is a schematic plan view of the horticultural apparatus 10 and an illustration of one way that the apparatus may be cut to facilitate installing a plant in the soil beneath the apparatus. For a selected plant location, an “H-shaped” cut may be made with the “H” centered over the selected plant location and each cut line following a connection portion between basins 20. After cutting the apparatus along the required three cut lines, the H-shaped cut forms a pair of opposing flaps. In this example, each flap includes a 4×3 section of basins. These two flaps may then be folded back over the top or under the bottom of the apparatus so that young plants can be planted in the soil area exposed by the flaps. It should be recognized that many other cuts may be made and effective used. For example, “U-shaped” cuts may form a single flap, or “X-shaped” cuts may form four flaps. Alternatively, a square or circular section may be completely cut out of the apparatus.

The translucent horticultural apparatus may be used by any person or entity that wants to better manage soil conditions, such as an amateur gardener, landscape contractor, or plant nursery operator. The apparatus may be used without limitation as to the types of plants or the location of the soil, but is intended to be beneficial for growing vegetables, other garden plant, or landscaping plants.

In one embodiment, the soil may be loosened and aerated by rototilling, perhaps incorporating organic matter or fertilizer to aid growth of plants yet to be installed in the soil. The translucent horticultural apparatus is then placed over the soil with the basin holes against the soil. Walking on the apparatus may be beneficial to press the holes into the soil surface. However, rain or irrigation will also tend to break up clods of soil and generally smooth out the soil such that more and more of the holes will engage the soil surface over time. It is desirable for the holes to engage the soil so that any water collected in the basin does not merely run through the hole onto the soil where the water may run off. Rather, when the holes in the basins engage the soil, water collecting in the basins will be slowly released into the soil through the holes as the soil is able to take on the additional water. It is also important to maintain an air space under the canopy so that the radiant energy is captured for heating the soil.

FIG. 10B is a schematic side view of the horticultural apparatus 10 positioned on the soil 14, where the horticultural apparatus has been cut and folded as illustrated in FIG. 10A to facilitate the installed plant 100.

As long as the diameter of the cut hole in the apparatus is not greater than about 6-8 inches, it is expected that an exposed area of the soil will still benefit from the soil warming and soil moisture retention properties of the horticultural apparatus. Optionally, the slits or cut-outs may be prefabricated or implemented on site. In either situation, it is preferable to allow the horticultural apparatus to warm the soil prior to cutting flaps or removing a section of the polymeric sheet.

The terminology herein is used for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A horticultural apparatus for managing soil conditions, comprising:
a nonporous and translucent polymeric sheet forming a two-dimensional array of basins defining an upper plane and a lower plane, each basin having a rim in the upper plane, a base in the lower plane, sidewalls that slope inwardly from the rim to the base, and a hole in the base, wherein the polymeric sheet connects the rim of each basin to the rims of each adjacent basin to form a continuous canopy between the basins.

2. The horticultural apparatus of claim 1, wherein the continuous canopy prevents air convection through the polymeric sheet when the hole in each basin is pressed against the soil.

3. The horticultural apparatus of claim 1, wherein the only holes through the polymeric sheet are the holes in each basin.

4. The horticultural apparatus of claim 1, wherein the basins of the two-dimensional array are arranged in rows and columns.

5. The horticultural apparatus of claim 1, wherein the basins of the two-dimensional array are arranged in parallel rows, and wherein the polymeric sheet is bendable between the rows.

6. The horticultural apparatus of claim 5, wherein the polymeric sheet can be bent and stored in a rolled up configuration.

7. The horticultural apparatus of claim 1, wherein the rim of each basin has a diameter between 0.5 and 3 inches.

8. The horticultural apparatus of claim 1, wherein the rim of each basin has a diameter between 1 and 2 inches.

9. The horticultural apparatus of claim 1, wherein the upper plane and the lower plane are separated by a distance between 0.5 and 2 inches.

10. The horticultural apparatus of claim 1, wherein the plurality of basins are uniformly sized and shaped.

11. The horticultural apparatus of claim 1, wherein the basins along a first edge of a first instance of the polymeric sheet will nest in the basins along a second edge of a second instance of the polymeric sheet.

12. The horticultural apparatus of claim 1, wherein the hole in the base exposes a downwardly directed edge of the sidewalls to engage the soil.

13. The horticultural apparatus of claim 1, wherein the sidewalls of each basin define a frustum having a major base in the upper plane and a minor base in the lower plane.

14. The horticultural apparatus of claim 13, wherein the rims of the basins in the two-dimensional array are disposed in a close-packed arrangement.

15. The horticultural apparatus of claim 13, wherein the rims of the basins in the two-dimensional array are separated by a distance that is less than a diameter of the rims.

16. The horticultural apparatus of claim 13, wherein the frustum is a right frustum.

17. The horticultural apparatus of claim 13, wherein the major and minor bases of the frustum are a regular convex polygon.
